(19) United States
(12) Patent Application Publication
(10) Pub. No.: US 2006/0271856 A1
(43) Pub. Date: Nov. 30, 2006

(54) Interface design system and method with integrated usability considerations

(75) Inventors: Michelle A. Raymond, Minneapolis, MN (US); Todd P. Carpenter, St. Paul, MN (US); Christopher A. Miller, St. Paul, MN (US); Dal Vernon C. Reising, Minneapolis, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/137,309

(22) Filed: May 25, 2005

(51) Int. Cl. G06F 19/00

(52) U.S. Cl. 715/730; 715/745; 700/91

(57) ABSTRACT

A method of user interface design including creating an interaction requirement and generating one or more available presentations configured to meet the interaction requirement, where generating includes identifying available presentation devices based upon the device model and meeting the interaction requirement and determining one or more available presentation elements configured to meet the interaction requirement. The device model includes a plurality of attributes and characteristics of a presentation device meeting the interaction requirement. Each presentation element is configured to be communicated to a user via at least one of the available presentation devices. The method further includes assigning each of the plurality of available presentations a usability score, selecting one or more of the available presentations based at least in part upon the usability score of each of the available presentations, and designing a user interface incorporating one of the available presentations.

### CROSS-REFERENCE TO RELATED APPLICATIONS

This application is related to Ser. No. ______ filed concurrently herewith, entitled “Domain Modeling System and Method” and having the attorney docket number H0003522-0760, which is incorporated by reference herein in its entirety.

### BACKGROUND

The present invention relates to an interface design system and method of use. More particularly, the present invention relates to an interface design system and method for modular generation of user interfaces with integrated usability considerations that produces adaptable or static user interfaces.

Many tools have been created to aid a human in the design of products and/or performance of particular tasks. These tools, however, are not easily adaptable to changing environments as each tool is designed for a specific use and specific domains with specific devices in hand. These tools are not flexible. For example, many computer aided design (CAD) systems that aid in the design of integrated circuits do not also aid in the design of automobile engines. In addition, these tools only provide a limited capability, at most, of designing an interface between the product or system being designed and an end user of that product or system. Otherwise stated, conventional systems for design typically allow a designer to design a particular user interface or series of user interfaces for use in a single domain, a single group of tasks, a single set of delivery devices that can be used by the user to access the system, and particular roles of the users within the system, but not for all simultaneously. Typically, generation of user interfaces for various programs, activities, and tasks is completed by selecting individual templates for performing each task or sub-task and subsequently manually linking each template together on an individualized basis. As such, conventional systems that assist in user interface generation are designed to aid the designer in generation of single interfaces for a given domain or task, but do not typically assist in the linkage of and/or arranging the multiple task-based interface objects together.

In such systems, not only must the designer manually arrange and connect the various templates and personalize each template for a specific use, but the designer must also make the choice of what template or sequence of templates to use for a specific task. Accordingly, these designer decisions were typically decided by the mindset of the designer alone. As such, although the designer may choose templates he or she believes to best communicate information with the user, no upfront analysis is given to the usability of a particular or series of user interface presentations to the end user. To this end, previous design systems for user interface generation primarily focused on the speed of presentation development rather than the quality of the presentations from the perspective of the end user.

In some instances, following complete development of a program, user studies or usability statistics have been developed to rank or score the usability of a particular system and/or to identify particular aspects of a system that could be transformed to better serve an end user. However, such systems and statistics are only used to evaluate a program after its initial construction has been completed and initial template arrangement and design is complete.

With this in mind, a user interface generation system is desired that intelligently incorporates usability of presentations into the initial modular design of a program or task.

### SUMMARY

One aspect of the present invention relates to a method of user interface design. The method of user interface design includes creating an interaction requirement includes creating an interaction requirement and generating one or more available presentations configured to meet the interaction requirement including identifying available presentation devices based upon the device model and determining one or more available presentation elements configured to meet the interaction requirement. Each presentation element is configured to be communicated to a user via at least one of the available presentation devices. Each of the available presentation devices meets the interaction requirement. The method further includes assigning each of the plurality of available presentations a usability score, selecting one or more of the available presentations based at least in part upon the usability score of each of the available presentations, and designing a user interface incorporating one of the available presentations. The device model includes a plurality of attributes and characteristics of a presentation device meeting the interaction requirement. Generating one or more available presentations.

Another aspect of the present invention relates to a user interface design system including an input device, a memory, a processor, and an output device. The memory stores a plurality of presentation elements, a plurality of usability criteria, at least one usability rule, and at least one user-centered algorithm. The processor is coupled with the input device and the memory and is configured to generate available presentations meeting an interaction requirement constructed by a triggering action from the input device. The available presentations each includes at least one of the plurality of presentation elements and at least one presentation device configured to communicate the at least one presentation elements. The processor is further configured to apply the plurality of usability criteria and to generate a collective usability score for each of the available presentations. The output device is coupled with the processor and configured to receive the at least one available presentation from the processor and to interface with a designer to present the at least one available presentation to the designer.

Yet another aspect of the present invention relates to a computer-readable medium having computer-executable instructions for performing a method of designing a user interface. The method includes creating an interaction requirement, generating available presentations meeting the interaction requirement and including at least one presentation element and at least one presentation device, assigning each of the available presentations a collective usability score based on a plurality of usability criteria, selecting one or more of the available presentations based at least in part upon the collective usability score of each of the available presentations, and presenting the selected one or more of the available presentations to a user-interface designer.

### BRIEF DESCRIPTION OF THE DRAWINGS

FIG. 1 is a block diagram illustrating a computer system useful in implementing a user interface system according to one embodiment of the present invention;

FIG. 2 is a block diagram illustrating the general architecture of the user interface generation system according to an embodiment of the present invention;

FIG. 3 is a flow chart illustrating one embodiment of a task module of the user interface generation system of FIG. 2;

FIG. 4 is a flowchart illustrating a method of generating a user interface in accordance with one embodiment of the present invention;

FIG. 5 is a schematic illustration of one embodiment of an available presentation and associated usability criteria scores generated in the method of FIG. 4;

FIG. 6 is a schematic illustration of one embodiment of an available presentation and associated usability criteria scores generated in the method of FIG. 4; and

FIG. 7 is a table illustrating alternate embodiments of collective usability scores for the presentations of FIGS. 5 and 6 generated in the method of FIG. 4.

### DETAILED DESCRIPTION

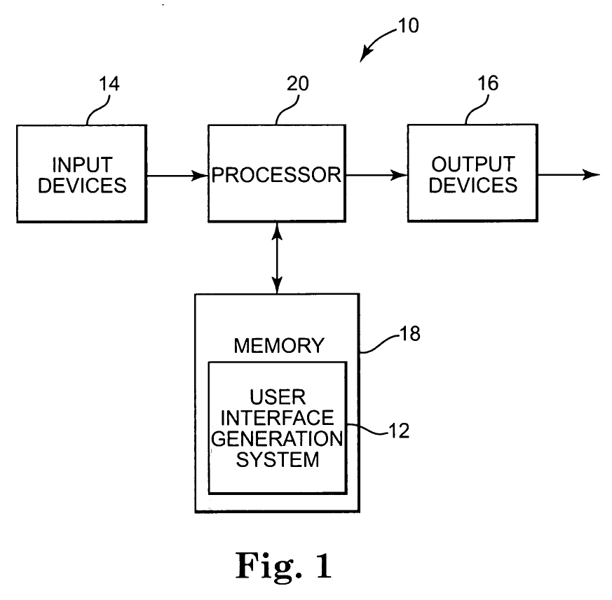

One embodiment of a computer 10 for implementing a user interface generation system 12 is generally illustrated in FIG. 1. The computer 10 includes one or more input devices 14, one or more output devices 16, a memory 18, and a processor 20. Input and output devices 14 and 16 allow a designer to interact with the processor 20 as well as the user interface generation system 12 for the development and generation of user centered user interfaces. In particular, the user interface generation system 12 interacts with the designer to generate end presentations that have been evaluated with usability criteria.

In one embodiment, the one or more input devices 14 include devices such as a keyboard, a mouse, and/or a modem that can be accessed by the designer to provide various input to the interaction design system 12 to design and generate user interfaces. For example, the designer can use a keyboard of input devices 14 to provide task, user, domain, or other information to user interface generation system 12. In another example, task, domain, and/or user information is generated remotely and provided to the design system 12 via a modem of input devices 14. In addition, input devices 14 may include a drive for receiving one or more of various types of memory storing information previously generated by the designer. Notably, the designer as used herein refers to any user of the user interface generation system 12 that is generating or assisting in the generation of a user interface. Accordingly, the designer refers to the initial designer as well as any middle designer modifying or further customizing a user interface for a particular domain, task, user, etc.

In one embodiment, output device 16 includes one of a printer, a display for presenting visual, audio, and/or other output, and a modem facilitating designer interaction with the interaction design system 12 on computer 10. Notably, a single modem may be used as one of the input devices 14 and the output devices 16.

Memory 18 includes volatile memory (e.g. random access memory (RAM)) and/or non-volatile memory (e.g. a hard disk drive or other persistent storage device). The memory 18 stores the user interface generation system 12 that is executed by the computer 10 to design and generate user interfaces, and may be used and accessed by the user interface generation system 12 during execution. In one embodiment, the memory 18 is further used to store various inputs that may be created by the designer and that are used by the user interface generation system 12 to generate user interfaces. In one embodiment, the various inputs are stored within the memory 18 in the form of models and libraries that can be reused in subsequent generation of additional user interfaces.

The processor 20 is electronically coupled via a hard-wired or wireless connection with input devices 14, output devices 16, and memory 18. In one embodiment, the processor 20 includes hardware, software, firmware, or a combination of these. In one embodiment, the processor 20 includes a computer server or other microprocessor based system capable of performing a sequence of logic operations. Communications with the end user via input devices 14 and output devices 16 are sent via the processor 20. In addition, the processor 20 accesses the memory 18 during functioning to define or complete various tasks as asked of the processor 20. In one embodiment, the processor 20 is coupled with the memory 18 via the internet or a server system.

Notably, components of the present invention can be implemented in hardware via a microprocessor, programmable logic, or state machine, in firmware or in software with the given device. In one aspect, at least a portion of the software programming is web-based and written in Hyper Text Mark-up Language (HTML) and/or Java programming languages, including links to interfaces for data collection, such as a Windows based operating system. Each of the main components may communicate via a network using a communication bus protocol. For example, the present invention may use a Transmission Control Protocol/Internet Protocol (TCP/IP) suite for data transport. Other programming languages and communication bus protocols suitable for use with the present invention will become apparent to those skilled in the art after reading this disclosure. Components of the present invention may also reside in software on one or more computer-readable mediums. The term “computer-readable medium,” as used herein, is defined to include any kind of memory, whether volatile or non-volatile, such as floppy disk, hard disk, CD-ROMs, flash memory, read-only memory (ROM) and random access memory (RAM). The term “computer-readable medium” is also used to represent carrier waves on which the software is transmitted.

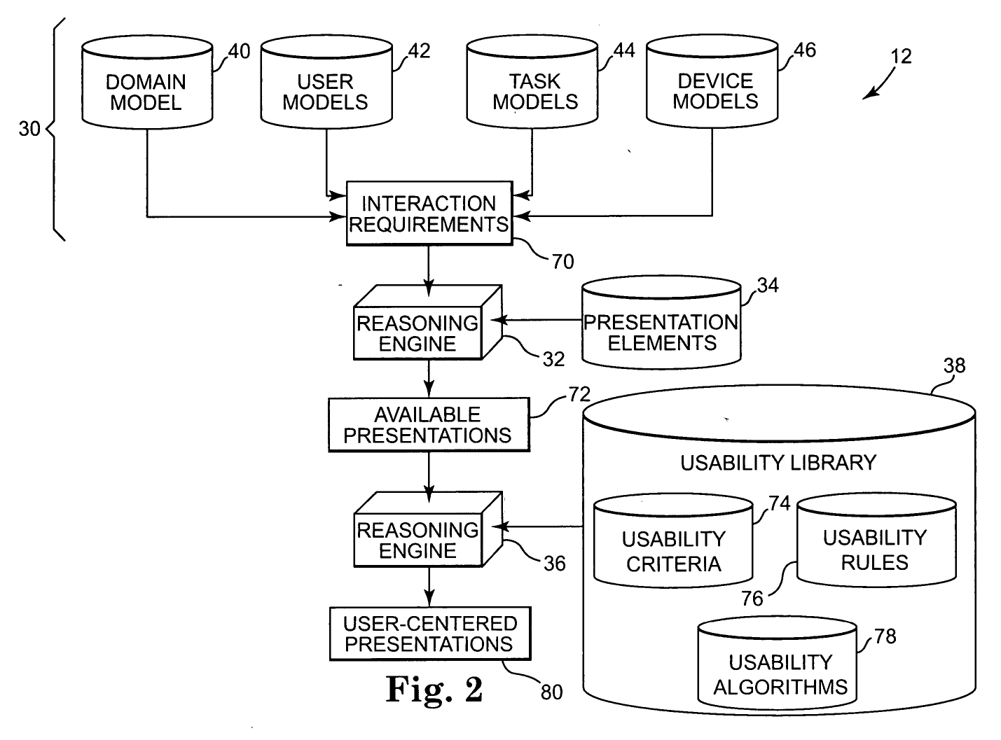

FIG. 2 illustrates the general architecture of the user interface generation system 12. The user interface generation system 12 includes various inputs 30, a reasoning engine 32, presentation elements 34, a reasoning engine 36, and usability library 38. The various inputs 30 include a domain model 40, user models 42, task models 44, and device models 46. The domain model 40 is a machine interpretable domain-specific representation of the relevant domain attributes to be given to a user interface. These attributes include the data, information, concepts, and/or relations pertinent to the application and domain for which the user interface is being designed.

More specifically, the domain is a particular generalized arena in which the user interface will be operating. Accordingly, in one embodiment, the domain model 40 includes a description for each of a plurality of element types operating within the domain, wherein each element type generally describes a group or type of element including the common characteristics and relationships to other element types. Specific instances fitting within each element type are also defined. As such, each instance fits the generalized attributes and relationships of the element type, but in addition, the characteristic and relationships are more specifically described.

For example, in a domain of prescription tracking, a doctor would be an element type defined to have general attributes, such as a name, certain degrees, specialties, etc., and general relationships, such as a relationship to a group of patients. The element types, thereby define the basic rules of interconnectivity between element types within the interface generation system 12. Instances are also included in the domain model. An instance is a specifically defined subset of the element type. Continuing the above example, an instance of the element type would be a specific doctor, such as Dr. John Doe. Each instance, in this case Dr. John Doe, is described as having particular attributes, such as an endocrinology specialty, and particular relationships, such as particular patient names. In this manner, the domain is broken down into component parts (i.e., element types and instances) all of which are defined within the domain model 40.

In one embodiment, this domain model dichotomy allows a generalized domain to be partially modeled by defining element types. The generalized domain model subsequently can be customized for use in a particular setting. For example, general prescription tracking domain can be modeled including element type descriptions. The general prescription tracking domain is subsequently customized for use in a particular hospital or medical network by modeling the particular instances for that hospital or medical network.

The user models 42 are similarly created by the designer who captures the preferences, roles, abilities, and limitations, if any, of the users who are identified by the designer as the potential users of the user interface being designed. In one embodiment, the preferences, roles, and abilities of the users are captured using a flexible notation, such as Resource Description Framework (RDF). The preferences, roles, and abilities of the users in one embodiment include individualized role descriptions, delivery device preferences, modality, such as visual or audible preferences, physical challenges that may confront the users of the user interface being designed, etc. With this in mind the designer can best develop a user centered interface by understanding the capabilities and preferences of the user and the application requirements and using that understanding to create the user models 42 to define the relationship between the users and the application and the particular preferences of the user as they deal with the application.

In creating the task models 44, the designer considers the actions to be performed by the users accessing the user interfaces, the goals to be achieved by the user when using the user interface, and the information required to perform such actions and to achieve such goals. In this manner, the task models 44 capture what actions on the part of the user the interfaces are intended to afford or support. In one embodiment, the task models 44 can be captured using a flexible notation such as RDF. In modeling a particular task, the designer decomposes each task or interaction to be performed into a sub-task, if any, which is then transformed into task primitives, an order of flow from each task primitive, and the type of information required by each task primitive.

A task primitive is any of the basic actions that a designer is likely to require between users and the user interface for relevant application in the relevant domain. For example, in one embodiment, task primitives include at least one of the following: receive, instantiate, compare, monitor, assert, select, control, retract, change, detect, direct attention, navigate, adjust, and any synonyms of the above task primitives, etc. Notably, each task primitive is expressed from the perspective of the end user. In particular, “receive” is used to describe the user's receipt of information rather than “sent,” which would be described from the computer's perspective. Systems can also be developed from the data flow or process-centric view. However, in one embodiment, the user-centric approach described above lends itself to easier applicability of usability scoring.

The order of flow refers to the precedence or chronological order between multiple task primitives as can be designated and expressed by junctions and links in the notation applied to the task model 44. For example, such junctions include AND, OR and XOR junctions that may be synchronous or asynchronous. Links, for example, indicate that action B does not start before action A completes, that action A must be followed by action B, that action B must be preceded by action A, that actions A and B are both required, etc.

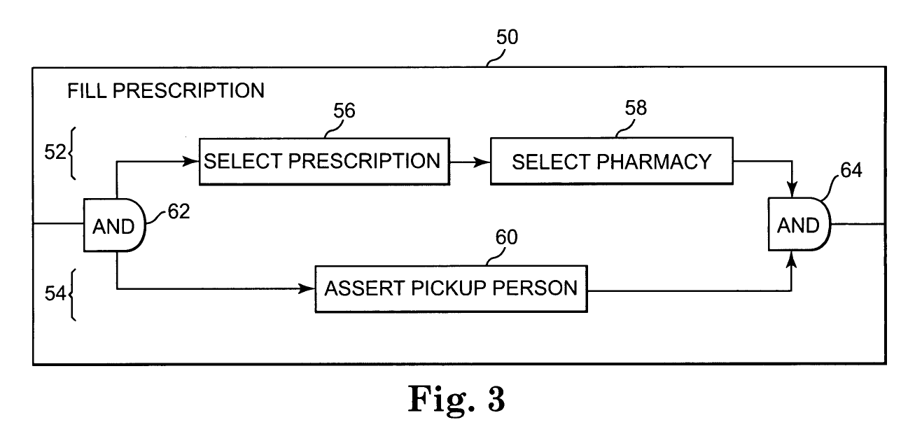

One example embodiment of a task model 50 with task primitives in an order of flow is generally illustrated in FIG. 3. The general task 50 is to fill a prescription when ordered for fill and pick up. For the sake of this example, assume that the different pharmacies available are dependent on the prescriptions to be filled (i.e. that only particular pharmacies can fill certain prescriptions) and that the pick-up person is not related to either the prescriptions type or the pharmacy selected. The larger task of filling the prescription 50 is divided into task paths 52 and 54, wherein each task path represents at least one or a series of tasks to be sequentially performed.

For example, task path 52 includes task 56 and task 58 which are dependent upon one another. In particular, task 56 allows a user to select the prescriptions they wish to be filled and task 58 allows a user to select the pharmacy they wish to fill their prescription and from which to pick-up their prescription. Because the pharmacies that can be selected is dependent upon which prescriptions the user chooses, the task of selecting a pharmacy 58 is performed subsequent to the task of selecting the prescriptions to be filled 56. In other words, once the task of selecting a prescription is complete, then and only then can a pharmacy be selected and verified.

Conversely, as shown by task path 54, the sub-task of asserting a pick-up person 60 is not dependent upon any other task or sub-task. Therefore, the sub-task of asserting a pick-up person 60 independently comprises the entire task path 54. However, to fully permit the pharmacy to fill a prescription, the user must perform both the first task path 52 and the second task path 54. As such, the task paths 52 and 54 are linked with the junction “AND.” In one embodiment, the junction is indicated by entrance junction 62 and exit junction 64. In particular, upon entering a task, entrance junction 62 indicates which and how task paths 52 and 54 are to be attacked. By indicating AND, entrance junction 62 indicates that both task paths 52 and 54 must be completed to fully perform task 50. The exit task 64 indicates which task path 52 and 54 must be completed prior to completion of the larger task 50. As such, by including the junction “AND,” exit junction 64 requires both task path 52 and task path 54 to be completed prior to completion of the overall fill prescription task 50.

In addition, the task models 44 also include the information required by the task primitives of the task being modeled. For example, the task primitive “receive” requires that information is to be received by the user. Accordingly, the designer defines the specified type of information that is needed for the task primitive in the particular task model 44. In particular, in the example illustrated in FIG. 3, in order to perform the task primitive “select” of the sub-task 56 to select prescriptions, information is needed regarding possible prescriptions that may be selected. Following building of particular tasks, such as task 50 including the information needed for each particular task and sub-task, the task models 44 are complete. In one embodiment, task models 44 include multiple task models that have been previously modeled and that can be later selected for subsequent interface generation and/or task modeling. In other embodiments, partial task models exist for use as templates for quickly forming similar task models.

A device model 46 is defined for each possible device available for use with the particular interface being modeled. Rather than merely listing the device name, each device model 46 specifies a particular device based upon the capabilities and modalities of the delivery device available to the end user to execute the interface and relevant to the application. In one embodiment, the capabilities include at least one of available bandwidth, memory, screen size, lines of display, width of display, illumination, etc., and the modalities include visual, audible, etc. In one embodiment, the specifications and characteristics are captured using flexible notation such as RDF.

In one embodiment, modalities and capabilities for the particular device are described with respect to input modalities and capabilities and output modalities and capabilities. The modular nature of the device models 46 allows new technology devices to be easily incorporated into existing systems. In particular, new devices are added by describing the device capabilities and modalities. This ability allows the user interface generation system 12 to adapt to impending advancements in the technological field of electronic devices. In one embodiment, modeled devices include web browsers, personal digital assistants (PDA), telephonic interaction delivery devices, personal computers, cell phones, analog phones, etc. The domain model 40, the user models 42, the task models 44, and the device models 46 are each stored in the memory 18 in preparation for the execution of the user interface generation system 12.

Each of the domain model 40, the user models 42, the task models 44, and the device models 46 combine to at least partially define interaction requirements 70 of the user interface being designed. Each interaction requirement 70 is a combination of a task primitive and information required by the task primitive as influenced by the characteristics of the users and the application and domain for which the user interface is being designed. Therefore, a user interface typically involves a plurality of interaction requirements 70 that define the totality of the way in which the user is expected to interact with the user interface being designed.

The reasoning engine 32 of the interaction design system 12 is configured to make qualitative judgments about the presentation elements available to support the performance of the various interactions required of the user interface being designed and the input and output of the information required by the interaction requirements 70. In one embodiment, the reasoning engine 32 is defined as part of the processor 20 (FIG. 1) of computer 10. In particular, the reasoning engine 32 is configured to match available presentation elements with the interaction requirements 70 to define available user interfaces that best perform the interactions as required by the user.

The available presentation elements are stored in the presentation elements library 34. A presentation element corresponds to specific presentation methods and defining the characteristics devices must possess to be capable of supporting the presentation method. In one embodiment, each presentation element also specifies the type of task primitive and the type of associated information the presentation method is designed to support. Otherwise stated, the presentation elements are the display objects that are used to present information to or to acquire information from a user of the user interface being designed. In the context of a web browser being used as the delivery device, a presentation element can include a pop-up menu, a pull down menu, a plain text element, a dialog box, a button, etc. As used herein, the term “display” refers to any output presentation, including one or more of a visual component, an audio component, and/or other mode components.

Accordingly, each of the presentation elements stored in the presentation elements library 34 contains a set of functionality and usability characteristics that the corresponding presentation element either supports or requires for correct application within a user interface presentation. The functionality and usability characteristics describe the quality of the interaction that can be achieved given the functionality and usability characteristics of the display objects. The functionality and usability characteristics for each presentation element should have a form so that they can be matched by the reasoning engine 32 to other inputs, and so that the reasoning engine 32 can make qualitative judgments about the ability of the presentation elements to support the input and output of the data to be exchanged between the users and the user interfaces. For example, within a particular task, the presentation element of a pull down menu may be well suited to a task of selecting from a group of items, but may not be well suited for use in inputting information not selected from a previously defined group or information unit. Accordingly, when the reasoning engine 32 considers the interaction requirements, it considers what needs to be completed by who and on what device by the user interface being designed.

Subsequently, the reasoning engine 32 accesses the presentation elements within the presentation library 34 to decide which presentation elements are available that can perform the necessary interaction requirements 70. As such, the reasoning engine 32 outputs available user interface presentations 72 which meet the interaction requirements. Notably, each presentation is a combination of an available device and the presentation elements to be displayed on the device. As such, the reasoning engine 32 not only defines which of the presentation elements 72 are available to perform the interaction requirements 70 but rather defines which combination of presentation elements and available devices is available to perform the interaction requirements 70.

In one embodiment, the reasoning engine 32 further scores each of the available presentations 72 to define which of the available presentations 72 best meets the interaction requirements 70. In one embodiment, the reasoning engine 32 only presents the designer with the available presentations 72 having the best or better scores than a certain percentage of other available user interface presentations. By scoring the available presentations 72 and only presenting a certain percentage or amount of those presentations, fewer available presentations 72 are presented to the designer for further evaluation, and therefore, the overall speed of evaluation of the available presentations 72 is increased.

The available presentations 72 presented by the reasoning engine 32 continue to the reasoning engine 36. The reasoning engine 36 is configured to perform qualitative judgments regarding the available presentations 72 and their ability to meet general non-task specific usability criteria as well as usability rules customized for the particular application being designed. In one embodiment, the reasoning engine 36 is part of the processor 20 of the computer 10 (FIG. 1). In one embodiment, the reasoning engine 32 and the reasoning engine 36 are each part of a single reasoning engine and are shown as separate reasoning engines 32 and 36 for illustrative purposes only.

In order to determine which of the available presentations 72 are user preferred, the reasoning engine 36 accesses the usability library 38. The usability library 38 includes usability criteria 74, usability rules 76, and usability or user-centered algorithms 78 defining how to collectively compare and analyze those criteria. In one embodiment, the usability criteria 74 includes criteria or parameters for analysis including at least one of display scope, display resolution, display bandwidth, display importance, display obtrusiveness, control scope, control resolution, control bandwidth, control importance, visibility, transmission speed, and/or modality type. Each of the usability criteria 74 stored within the usability library 38 additionally includes a definition of how to score that particular criteria. The usability criteria are selected based upon usability psychology, which is an area of cognitive psychology.

For example, in one embodiment, the usability criteria of visibility is scored on a scale of 1-10 by determining the percentage of the total available options displayed at one time. For example, if there are five options for a user to select from and a pull down menu only shows four of the five without scrolling, the user would see four of the five selections at one particular time. Therefore, 4/5 or 80% of the selections are shown at a single moment in time resulting in an overall visibility score of 8 (80% of 10) on a scale of 1-10. Similar processes are completed for each of the usability criteria ranking each of the criteria on a scale of 1-10. Notably, although described as ranking criteria on a scale of 1-10, usability criteria can be ranked on a variety of scales such as −1 to 1, 0 to 5, etc.

Following ranking of each of the criteria on a predefined scale, such as from 1 to 10, the criteria rankings are plugged into a user-centered algorithm selected from the usability algorithms 78 for determining a collective usability score based on which criteria are most important to the end user within a particular domain. In one embodiment, the user-centered algorithm is modular and can be defined specifically by the designer for particular situations. In one embodiment, the user-centered algorithm provides a weighted average method of determining the overall score.

In one embodiment, the user-centered algorithm includes references to or inclusion of one or more of the plurality of usability rules 76 stored in usability library 38. With this in mind, the user-centered algorithm can include if/then/else statements (such as if a user is a particular type, then apply a particular rule), enumerations, and other references. For example, an particular algorithm includes the statement that if the user fits within a definition of an elderly user, then apply any usability rules classified as general elderly rules, wherein the elderly rules may adjust the usability criteria score to raise the score of presentations with larger or easier to read displays, with linear information displays, or with other attributes generally thought to be beneficial to elderly users. Once the rules called out in the algorithm are applied, the results of the rules are plugged into the algorithm to derive a final collective usability score.

As such, each of the usability criteria is given a particular weight dependent upon the particulars of the algorithm and/or any rules that may apply to the algorithm. In particular, in one embodiment, after applying any specified rules, the transmission speed may be considered to be more important than overall visibility and, therefore, the transmission speed would be even a higher weight than the visibility within that particular user-centered algorithm. The final product of the user-centered algorithm provides the final collective score within the range of 1-10 that can be easily compared to the final collective scores of presentations produced by the user-centered algorithm.

In one embodiment, in determining which of the user-centered algorithms or usability rules the reasoning engine 36 should utilize to determine the collective score of each presentation, the reasoning engine 36 utilizes specific information from the user model 42. In particular, if the user model 42 shows a particular user to be deaf, the algorithm or rule may be designed to highly weight visibility scores while lowly weighting or zeroing out scores related to audible communication or audible modalities. Accordingly, presentations receiving the highest or best overall usability scores would be directly related to textural or visual communication versus audible communication to better serve the needs of the deaf user.

In other examples, the user model 42 may define other particular preferences of the user, such as to receive messages via certain modalities at certain times, by certain modalities when the user is at certain places, etc. Accordingly, the algorithms and rules can be defined to facilitate these user preferences. As such, each possible presentation is evaluated to determine the collective usability score and compared to decide which available presentations are best suited to a particular user or user group. Accordingly, the reasoning engine 36 reports the preferred user interface presentations 52 based upon their ranked collective usability scores. In particular, in one embodiment, the reasoning engine 36 submits only a portion, such as 1, 3, etc., of the preferred user presentations 52 as chosen from the presentations with the highest collective usability scores.

In one embodiment, the algorithm is generally a root mean squared algorithm. Notably, although predefined algorithms and usability rules may be included in the usability library 38 prior to use by a designer, the designer can also create new algorithms and usability rules for use and storage within the usability library 38. Accordingly, the designer can particularly choose which criteria are most important in certain situations and weigh them accordingly. In one embodiment, the designer can write the algorithm in an XML format rather than in a coded format. Accordingly, it is easier for a designer to define the algorithm for subsequent use. In addition, by allowing the designer to have some control over the available algorithms and the rules and criteria incorporated in each particular algorithm, different algorithms can be provided for different tasks, different user groups, etc. to provide a modular system allowing for increased flexibility in the design of the overall user interface being generated. In addition, not only the initial generator of a user interface may have access to providing these algorithms, but also middle users within particular user systems of the developed user interface may also have access to define the usability criteria algorithms and to change them without need to be well-versed in the aspects of code writing.

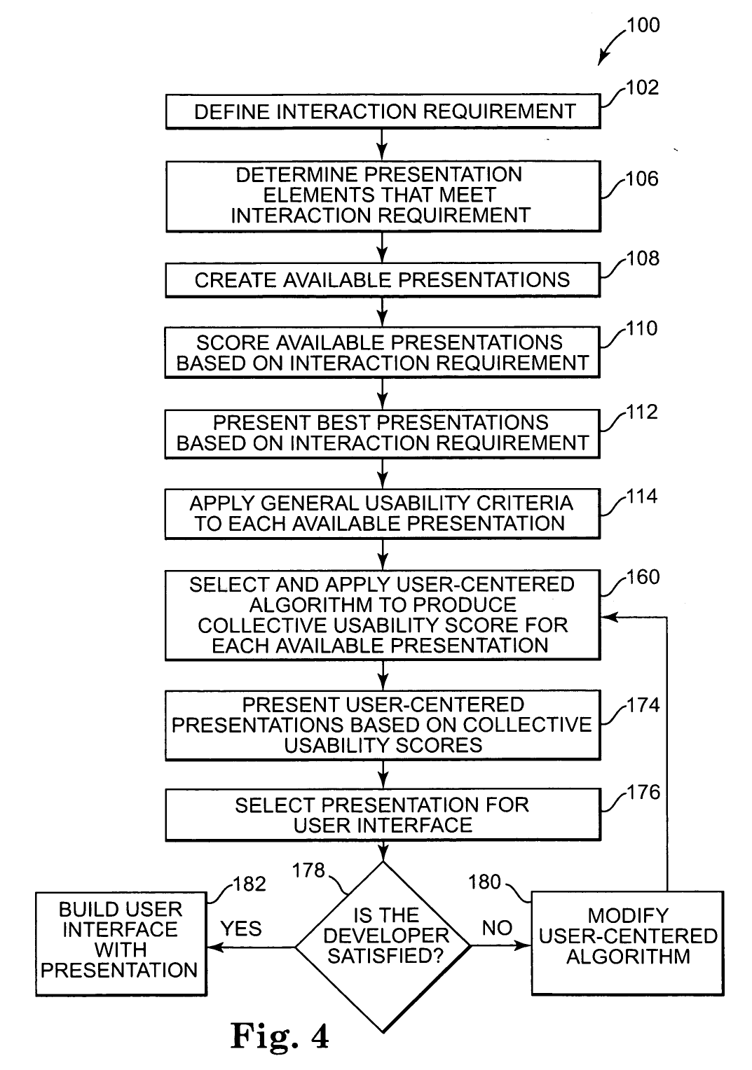

FIG. 4 illustrates a flow chart of one embodiment of a process for development of a user-centered user interface using the user interface generation system 12 generally at 100. Collectively referring to FIG. 2 and FIG. 4, at 102, the interaction requirement is defined. In particular, a domain model 40, user models 42, task models 44, and device models 46 relating to a particular action are defined. The models 40-46 are defined by creating new models and/or by selecting previously created models from the library or memory 18 (FIG. 1). Once the models 40-46 are defined, the collective result is the defining of the interaction requirement 70. In one embodiment, the interaction requirement 70 includes a list of available devices and/or a list of available presentation elements for a particular user or user group.

At 106, the presentation elements from presentation element library 34 are considered to determine which presentation elements are capable of meeting the interaction requirement 70. For example, if the interaction requirement includes a requirement for a graphical image presentation, then purely audible presentation elements, such as a phone menu, would be removed from future consideration for use in the user interface. In one embodiment, the construction or collection of available presentations is triggered by an action completed via the input device 14, such as pressing an enter key, completing a desired command sequence, etc. In one embodiment, no presentation elements may be available that meet the interaction requirement 70. For example, a device may be specified in the interaction requirement 70 that is not capable of supporting the only presentation elements available for a particular task primitive. In this embodiment, the developer is notified that no presentation element is acceptable, and the developer returns to 102 to alter the definition of the interaction requirement 70.

At 108, available presentations are created by combining the available devices that in conjunction with the available presentation elements are determined to meet the interaction requirement 70 at 104 with the available presentation elements determined to meet the interaction requirement 70 at 106. Notably, in the creation of available presentations, only the available presentation elements are combined with available devices capable of supporting the particular presentation element. For example, the visual presentation element of a pull-down menu generally cannot be combined with a non-visual device, such as an analog phone. In one embodiment, at least one of the available presentations includes multiple presentation elements in order to complete a task having multiple sub-tasks. However, in most situations usability is better when a single device is utilized, although this is not a strict design requirement.

Once the available presentations are created, the available presentations are scored based on how well each presentation meets the interaction requirement 70 at 110. In other words, each available presentation is scored on its ability to facilitate a particular task in a particular domain for a particular user or group of users. At 112, the available presentations that best meet the interaction requirement 70 are presented for further consideration. In one embodiment, the available presentations are not scored and ranked, but rather, all available presentations are forwarded to the reasoning engine 36 (FIG. 2) for further consideration for use in the user interface.

At 114, at least a portion of the general usability criteria 74 are applied to each available presentation forwarded to the reasoning engine 36. In particular, the reasoning engine 36 scores each presentation on a predetermined scale, such as from 1 to 10, on each of or at least a portion of the usability criteria stored in the usability library 38. In one embodiment, the general usability criteria are based on cognitive psychology studies.

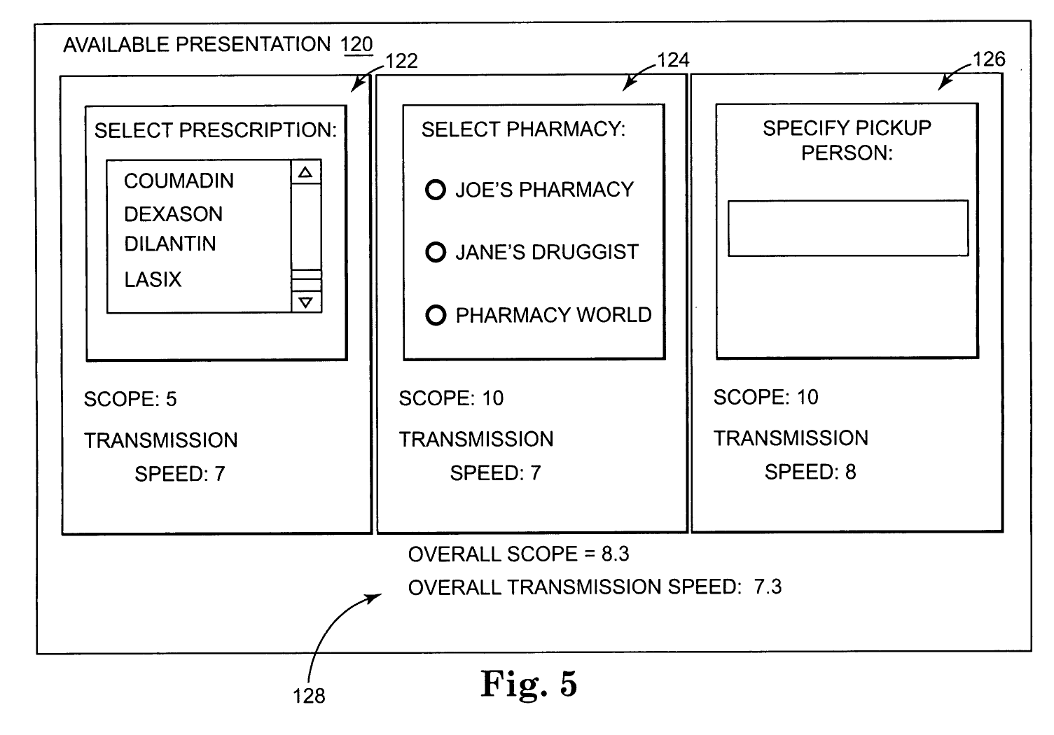

For example, FIG. 5 illustrates one embodiment of an available presentation 120 for the task of filling a prescription 50 illustrated with additional reference to FIG. 3. The available presentation 120 illustrated is for exemplary purposes and is not likely to be the best presentation once the usability rules are applied. The available presentation 120 utilizes a web-based browser device and includes three presentation elements 122, 124, 126 for performing the three sub-tasks 56, 58, and 60. Each of the presentation elements 122, 124, 126 is scored for a plurality of usability criteria as defined in the usability library 38.

In particular, the first presentation element 122 is a list box or performing the task of selecting a prescriptions 56. Assuming there are eight prescriptions that a particular user can choose from and only four prescriptions are shown on the first presentation element 122 without need for user scrolling, in one embodiment, the scope of display usability criteria is determined by dividing the number of prescriptions displayed at one time by the number of total prescriptions available (i.e., 50%) and converting the resulting percentage to the 1-10 scale, thereby producing a scope score of 5. Other individual usability criteria scores, such as a transmission speed score, can be similarly determined or may each be determined with a different type of formula to arrive at the particular score per instructions stored for each individual usability criteria in the usability library 38 (FIG. 2).

The second presentation element 124 is a check box that illustrates all three available pharmacies for a particular chosen prescription(s) for performing the task of selecting a pharmacy 58. Therefore, the second presentation element 124 has a scope score of 10. The third presentation element 126 is a text box that allows for a maximum of 25 characters to be entered, and as such, generally allows the entire name of the pickup person to be specified. This results in a scope score of 10 for the third screen 126. Once each of the presentation elements 122, 124, and 126 has been evaluated to determine the scope score of each, in one embodiment, the presentation 120 receives an overall scope score equal to the average of the scope scores of the individual presentation elements 122, 124, and 126, in this case an overall scope score equal to 8.3.

In other embodiments, the overall scope score may be determined by a weighted average equation, a root mean squared equation, etc. Formulas or algorithms for determining overall scope score or other overall usability scores are also obtained from the usability criteria 72 in the usability library 38 and, in one embodiment, are based on cognitive psychology research. A similar process is followed to determine a plurality of other overall usability criteria scores as specified in the usability library 38, for simplicity and illustrative purposes, only one other usability criteria score is illustrated, namely transmission speed, which has an overall transmission speed usability criteria score of 7.3.

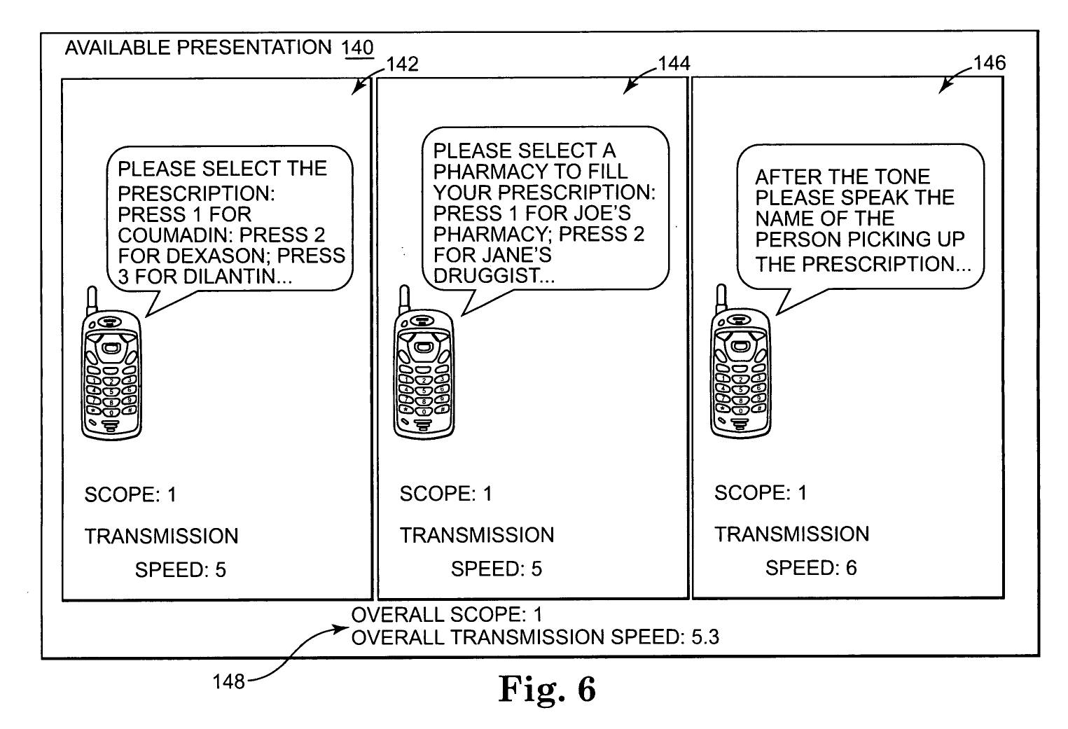

All other available presentations that have been forwarded to the reasoning engine 36 (FIG. 1) for consideration are similarly scored. For example, as illustrated in FIG. 6, a second available presentation 140 is illustrated utilizing a telephone as the device. The second available presentation 140 includes three presentation elements 142, 144, and 146 for performing the three sub-tasks 56, 58, and 60. In particular, the first presentation element 142 is a phone menu and audibly lists all of the prescriptions options, however, all the options are listed in a relatively slow manner as compared with the textual presentation element 122. Therefore, the presentation element 142 has a low scope score of 1 and a relatively low the transmission speed score of 5.

Similarly, the second presentation element 144 is another phone menu listing available pharmacies to be selected in the task 58. Accordingly, the presentation element 144 also has a scope usability score of 1 and transmission speed usability score of 5. The third presentation element 146 is a voice recognition prompt and has a scope usability score of 1 and a transmission speed score of 6. As a result, the overall scope and transmission speed usability criteria scores are 1 and 5.3, respectively.

Although only the scope and transmission speed scores are illustrated, preferably, each presentation will be scored for a larger number of usability criteria. Once the individual usability criteria scores are assigned to each of the presentation elements 142, 144, and 146 at 114, then at 160, the individual usability criteria scores are available as input to a user-centered algorithm selected from a group of usability algorithms 78 stored in the usability library 38 (FIG. 2). Notably, the user-centered algorithms stored in the usability library 38 may include previously defined user-centered algorithms merely selected for use and/or may include user-centered algorithms specifically created by the designer for a particular task, for use in a particular domain, for use with a particular user(s), etc. In one embodiment, at least some of the user-centered algorithms are based on cognitive psychology.

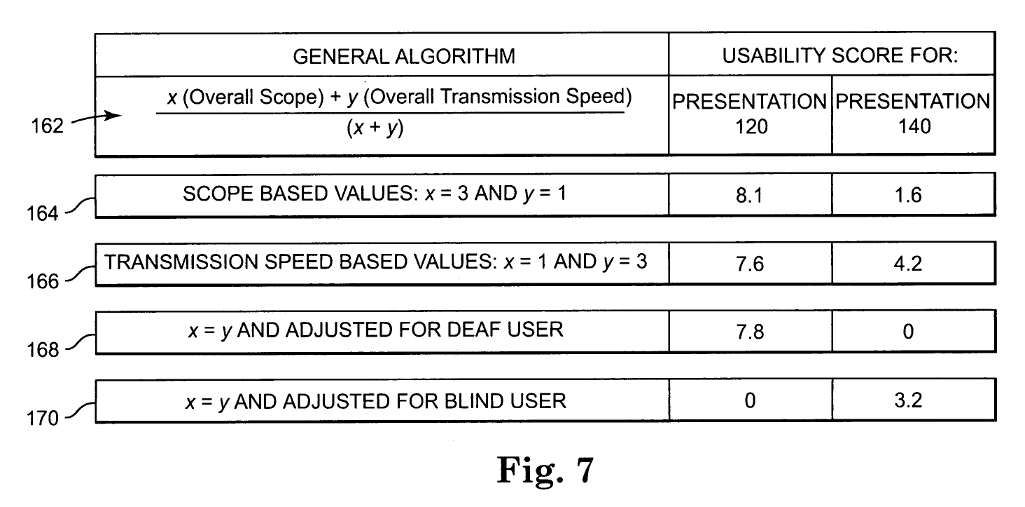

An example of a simplified user-centered algorithm is generally illustrated at 162 in FIG. 7. The user-centered algorithm 162 is a weighted average algorithm designating importance values, in this example, x and y, to each individual usability criteria. For example, in a situation in which the designer has determined that scope is of utmost importance as compared to transmission speed, the designer defines the user-centered algorithm and/or associated usability rule accordingly as illustrated in box 164. More specifically, if the designer determines that scope is three time as important to the end users as transmission speed, the designer would assign an importance value x to the overall scope at 3 while assigning an importance value y to the overall transmission speed of 1. Using this user-centered algorithm, the available presentation 120 would receive a collective usability score of 8.1 and the available presentation 140 would receive a collective usability score of 1.6. Accordingly, under these conditions, the available presentation 120 would be user preferred as compared to the presentation 140.

As an alternative example, in a situation in which the designer has determined that transmission speed is of utmost importance as compared to scope, the designer defines the user-centered algorithm and/or associated usability rules accordingly as illustrated in box 166. More specifically, if the designer determines that transmission speed is three time as important to the end users as scope, the designer would assign an importance value x to the overall scope at 1 while assigning an importance value y to the overall transmission speed of 3. Using this algorithm, the available presentation 120 would receive a collective usability score of 7.6 and available presentation 140 would receive a collective usability score of 4.2. Accordingly, under these conditions, the available presentation 120 would once again be user preferred as compared to the available presentation 140. Although generally described in the examples at 164 and 166 as being statically defined in the selected algorithm, it should be understood that in other examples the importance values x and y are dynamically defined by usability rules referred to by a more complex selected algorithm.

For example, in one embodiment, the user-centered algorithms are additionally or alternatively modified or selected based upon the particular preferences or capabilities of the user as defined by the user models 42 (FIG. 2). Accordingly, the particular modality also is weighted as defined by the designer of each user-centered algorithm and associated usability rules. In particular, in one embodiment, the user-centered algorithm includes application of a usability rule stating that “if the particular end user of an interface is deaf, then all collective usability scores relating to audible or verbal communications are equal to zero.” As such, while the available presentation 120 is initially scored in a similar manner as described above, the available presentation 140 receives a zero collective usability score due to its modality, more specifically, because it is entirely audible and would not be recognized by a deaf end user. Therefore, the system would select the textural presentation 120 as preferred for use by a deaf user as compared to the audible based presentation 140. A similar result is seen for blind users at box 170, which illustrates the visual items being given a score equal to zero due to associated usability rules resulting in the audible presentation 140 being noted as the preferred presentation as compared to the fully visual presentation 120.

Returning to FIG. 4, once the collective usability scores have been produced at 160, at 174, the presentations are sorted or ranked based upon the collective usability scores. Once sorted, only the presentations having the best, which in this example is the highest, usability scores are presented to a designer. In particular, in one embodiment, only the presentations having one of the top three collective usability scores are presented to the designer. In one embodiment, the only presentations presented to the designer are in the top or best 10% of the presentations scored. In one embodiment, only the one presentation with the highest collective usability score is presented to the designer.

At 176, the designer selects a presentation for use in the user interface from the presentation(s) presented to the designer at 174. Following selection, the designer can evaluate the selected presentation to ensure the designer is satisfied with the selection at 178. If the designer is not satisfied with the selection, at 180, the designer can modify or select another user-centered algorithm to apply to the individual usability criteria scores and repeat the steps 160-178 of the process 100. If the designer is satisfied with the presentation selection, at 182, the presentation is stored as part of the user interface. In one embodiment, at 182, the presentations are generated as an XML file and the selected device Extensible Stylesheet Language (XSL) is applied to the generated presentation XML file. As such, the presentation will be available to the end user on an appropriate application thereby making the user interface available to the end user.

A user interface generation system according to the present invention is a domain-independent and modular framework for developing user interfaces. The modular nature of the user interface generation system provides flexibility in creating a user interface that permits complete customization of the interface for a particular domain, task, device, and/or user(s). Otherwise stated, the user interface generation system facilitates automatic generation of domain specific, user role aware, task appropriate, device dependent, usability driven user interfaces. As a result, the user interface generation system not only aids a designer in relatively quickly creating a particular user interface, but also provides an end user interface tailored to best meet the needs of its probable users and to provide for increased system usability without the need for separate usability studies and multiple revisions of a user interface after its initial completion to achieve a desired usability standard.

Although specific embodiments have been illustrated and described herein it will be appreciated by those of ordinary skill in the art that a wide variety of alternate and/or equivalent implementations calculated to achieve the same purposes may be substituted for the specific embodiments shown and described without departing from the scope of the present invention. Those with skill in cognitive psychology and computer arts will readily appreciate that the present invention may be implemented in a very wide variety of embodiments. This application is intended to cover any adaptations or variations of the embodiments discussed herein. Therefore it is manifestly intended that this invention be limited only by the claims and the equivalence thereof.

What is claimed is:

1. A method of user interface design comprising:
creating an interaction requirement including a device model, wherein the device model includes a plurality of attributes and characteristics of a presentation device meeting the interaction requirement;
generating one or more available presentations configured to meet the interaction requirement including:
identifying available presentation devices based upon the device model, wherein each of the available presentation devices meets the interaction requirement;
determining one or more available presentation elements configured to meet the interaction requirement, wherein each presentation element is configured to be communicated to a user via at least one of the available presentation devices;
assigning each of the plurality of available presentations a usability score;
selecting one or more of the available presentations based at least in part upon the usability score of each of the available presentations; and
designing a user interface incorporating one of the available presentations.

2. The method of claim 1, wherein the interaction requirement is created in XML.

3. The method of claim 1, wherein the interaction requirement further includes at least one of a domain model, a user model, and a task model.

4. The method of claim 1, wherein assigning each of the available presentations a usability score includes:
scoring each of the available presentations for each of a plurality of usability criteria; and
collecting the scores for each of the plurality of usability criteria into one collective usability score for each of the available presentations.

5. The method of claim 4, wherein selecting one or more of the available presentations includes ranking the available presentations based upon the collective usability scores, and selecting one of the available presentations for use in the user interface based upon the ranking of each of the available presentations.

6. The method of claim 4, wherein selecting one or more of the available presentations includes:
presenting a selected portion of the available presentations to a designer, wherein the selected portion of the available presentations are the available presentations having better usability scores than a non-selected portion of the available presentations.

7. The method of claim 6, wherein the better usability scores are the higher usability scores.

8. The method of claim 6, wherein presenting a portion of the available presentations includes presenting a predetermined number of the available presentations having better usability scores than the non-selected portion of available presentations.

9. The method of claim 4, wherein collecting each of the plurality of usability criteria scores into one collective usability score includes plugging each of the plurality of criteria scores into a user-centered algorithm to provide the collective usability score.

10. The method of claim 9, wherein the user-centered algorithm is provided in XML format.

11. The method of claim 9, wherein the user-centered algorithm is a weighted average algorithm in which a weight is applied to each of the plurality of usability criteria scores based on the importance of the particular usability criteria to a probable end user.

12. The method of claim 11, wherein the weight applied to each of the plurality of criteria is based at least in part upon one or more of user capabilities and user preferences.

13. The method of claim 9, wherein the user-centered algorithm incorporates at least one usability rule, and further wherein the at least one usability rule is defined separately from the user-centered algorithm.

14. The method of claim 9, wherein the user-centered algorithm is selected from a group of user-centered algorithms stored in a usability criteria library including at least one designer generated algorithm.

15. A user interface design system comprising:
an input device;
a memory storing a plurality of presentation elements, a plurality of usability criteria, at least one usability rule, and at least one user-centered algorithm;
a processor coupled with the input device and the memory, the processor configured to generate available presentations meeting an interaction requirement constructed by a triggering action from the input device, and the available presentations each including at least one of the plurality of presentation elements and at least one presentation device configured to communicate the at least one of the plurality of presentation element, wherein the processor is further configured to apply the plurality of usability criteria and to generate a collective usability score for each of the available presentations; and
an output device coupled with the processor, the output device configured to receive the at least one available presentation from the processor and to interface with a designer to present the at least one available presentation to the designer.

16. The user interface design system of claim 15, wherein the processor is further configured to rank the available presentations based upon the collective usability score for each of the available presentations.

17. The user interface design system of claim 15, wherein the processor is configured to forward a portion of the available presentations to the output device for presentation to the designer, the portion being selected from the available presentations based upon the collective usability score for each of the available presentations.

18. The user interface design system of claim 15, wherein the collective usability score is based in part on a user-centered algorithm generated by the designer.

19. The user interface design system of claim 18, wherein the at least one user-centered algorithm is based on at least one of particular user capabilities and particular user preferences.

20. The user interface design system of claim 18, wherein the at least one user centered algorithm includes reference to one of the plurality of usability rules, and further wherein the one of the plurality of usability rules is separately defined from the user-centered algorithm.

21. The user interface design system of claim 20, wherein the one of the plurality of usability rules impacts the collective usability score based at least in part upon a user model.

22. A computer-readable medium having computer-executable instructions for performing a method of generating a user interface, the method comprising:
creating an interaction requirement;
generating available presentations meeting the interaction requirement and including at least one presentation element and at least one presentation device;
assigning each of the available presentations a collective usability score based on a plurality of usability criteria;
selecting one or more of the available presentations based at least in part upon the collective usability score of each of the available presentations; and
presenting the selected one or more of the available presentations to a user-interface designer.

23. The computer-readable medium having computer-executable instructions for performing the method of claim 23, wherein the interaction requirement includes a domain model, a user model, a task model, and a device model.

24. The computer-readable medium having computer-executable instructions for performing the method of claim 23, wherein assigning each of the available presentations a collective usability score includes:
assigning each of the available presentations a plurality of usability criteria scores, and
entering the plurality of usability criteria scores for each of the available presentations into a user-centered algorithm to result in the usability score for each of the available presentations.

25. The computer-readable medium having computer-executable instructions for performing the method of claim 24, the method further comprising:
ranking the available presentations based on the collective usability score of each of the available presentations;
wherein selecting one or more of the available presentations is based upon the ranking.
